(19) United States
(12) Patent Application Publication
(10) Pub. No.: US 2011/0271201 A1
(43) Pub. Date: Nov. 3, 2011

(54) Decentralized Contextual Collaboration Across Heterogeneous Environments

(76) Inventors: Mario R. Cavagnari, Scotts Valley, CA (US); Rodney Goodger, San Jose, CA (US); Michael Galloway, San Jose, CA (US)

(21) Appl. No.: 12/769,481

(22) Filed: Apr. 28, 2010

(51) Int. Cl. G06F 3/00; G06F 3/048

(52) U.S. Cl. 715/751; 715/835

(57) ABSTRACT

Methods and systems are described for enhancing applications, such as browser applications, to include contextual collaboration functionality within the application's user interface by providing a collaboration interface. The collaboration interface provides access to a group of collaboration data sets associated with a URL of the page displayed through the application according to user defined organization.

### BACKGROUND

1. Field of the Invention

The present invention relates generally to collaboration tools, and more particularly to providing an interface for access to decentralized collaboration data within an application, such as a browser or other application, which is contextual to the user of the application and the page being viewed through the application.

2. Description of Related Art

The world wide web is a source of a vast array of information. A user using a web browser application executing on a computing device can access and display information from various remote sources via a network. Users often browse the web to obtain reference information related to various topics. Given the vast amount of information available on the web, as well as within private networks, it is often difficult to locate useful information without significant effort.

From the perspective of the user, browsing is generally a solitary activity. As a result, a user wanting to share information from a web page with others, does so via communication such as email, instant messaging, phone calls, on-line conferencing and meetings. These types of communication are segregated from the web site the user is browsing, and thus the communication between users takes place outside of the context of the information being shared.

This lack of contextual continuity hinders the productivity of the users as well as the collaboration between the users. For example, a user may have to search their desktop computer, word processing programs, email systems and/or other outside applications and computer systems for the communications regarding a particular subject. In addition, stand-alone applications such as email and online conferencing require use on a separate basis, which is cumbersome, complicated and inefficient.

### SUMMARY

Methods and systems are described for enhancing applications, such as browser applications, to include collaboration functionality within the application's user interface by providing a collaboration interface in full context. The collaboration interface provides access to a group of collaboration data sets associated with a uniform resource locator (URL) of the page displayed through the application, page title, domain or other criteria according to user defined organization.

A method as described herein includes receiving a request for display of a first page through an interface of an application executing on a computing device, the request associated with a user. The method includes retrieving identification data of one or more collaboration data sets associated with the user and further associated with a URL of the first page. The method further includes displaying the first page within the interface of the application and displaying one or more icons within the interface of the application. Respective icons in the one or more icons represent a corresponding collaboration data set in the one or more collaboration data sets. The icons are selectable to display collaboration data associated with the corresponding collaboration data set.

Other aspects and advantages of the present invention can be seen on review of the drawings, the detailed description, and the claims which follow.

### BRIEF DESCRIPTION OF THE DRAWINGS

FIG. 1 is a block diagram of an exemplary system for providing contextual collaboration functionality.

FIG. 2 illustrates an example hierarchical data model diagram for the collaboration data sets.

FIG. 3 illustrates an example hierarchical data model diagram for the collaboration data sets within the collaboration data system which includes “containers”.

FIG. 4 is an illustration of an example association between URL's and a user's accessible collaboration data sets.

FIG. 5 is a flow chart of an exemplary computer implemented method for providing a collaboration interface.

FIG. 6 is a flow chart of a method for displaying collaboration data.

FIG. 7 illustrates an exemplary collaboration interface.

FIG. 8 illustrates an exemplary collaboration interface.

FIG. 9 is a flow chart of an exemplary method for associating a URL with one or more collaboration data sets.

FIG. 10 illustrates an exemplary computing system that may be used to implement aspects of the present invention.

### DETAILED DESCRIPTION

Methods and systems are described for enhancing applications, such as for example browser applications and client applications, to include collaboration functionality within the application's user interface by providing a collaboration interface in full context. The collaboration interface includes icons selectable to provide access to a group of one or more collaboration data sets (or “boxes”) associated with a URL of the page displayed through the application, page title, domain or other criteria according to user defined organization. The collaboration interface may for example be invoked automatically using code embedded within the page by an administrator, which is executed by the application during the display of the page. Alternatively, the collaboration interface may be invoked in response to user input such as a selection by the user of a bookmarklet located in a toolbar of the application. The collaboration interface provides the user with the ability to change the nature of the page displayed through the application by offering collaboration mechanisms and a way for the user to bring and interact with additional content. The collaboration interface empowers the user to access and associate collaboration data sets on top of an application, page, document, or field.

The present technology relates to collaboration of web content and navigating web content as well as large quantities (such as hundreds/thousands) of applications, business applications, reports, dashboards, and so forth. A user can collaborate in the context of these applications and bring their own content to applications, thereby providing additional context to application content they interact with.

Previously, users interact with multiple Enterprise systems, e.g. HR, ERP, CRM, Portals, Dashboards, reports, which provide virtually no collaboration mechanisms. To collaborate, users communicate information via e-mail or to a centralized collaboration application. As the collaboration process is utilized on an application separate from the subject of the collaboration, context is lost for the system to which the collaboration pertains. The result: collaboration without context, which equates to slower and less effective collaboration.

The association between URL's and the collaboration data sets is contextual to the user. As a result, separate users accessing the same page have customizable collaboration interfaces which can provide access to unique groups of collaboration data sets. Thus, when accessing a page, each user sees a custom collaboration interface which is contextual to the user and the URL of the page.

The collaboration interface allows collaboration data from collaboration activities conducted outside the application to be contextually viewed seamlessly within the application. The collaboration data can be stored and managed locally or outside the application using a separate collaboration server, and may be accessible via both the application, as well as one or more other applications.

The collaboration data may include for example one or more items of media data including images, video, audio or other data, that a user may associate together within the collaboration data set. The data may be stored on one more datastores, and may be accessed through selection of an icon through the collaboration interface. One or more users may add data to the collaboration data set, and one or more users may collaborate on the data associated with the data set. Users that add or view the data associated with the data set or participate in providing content associated with the added content, such as by providing comments, participate in collaboration associated with the particular collaboration data set (i.e., data that has been associated with the data set).

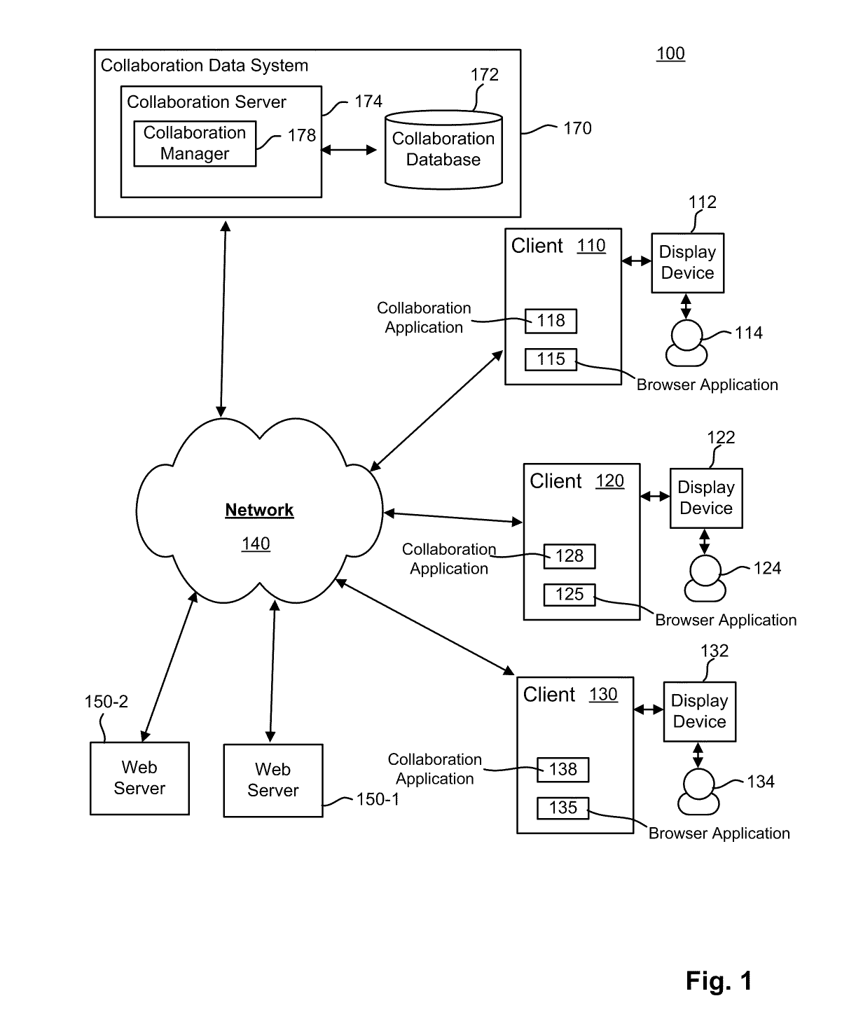

FIG. 1 is a block diagram of an exemplary system 100 for providing contextual collaboration functionality from within the user interface of an application such as a browser application according to user defined organization.

The system 100 includes client devices 110, 120 and 130 that may be utilized to facilitate collaboration between associated users, web servers 150-1 and 150-2, a collaboration data system 170, and a communications network 140.

The client devices 110, 120 and 130 include display devices 112, 122 and 132 respectively. Users 114, 124 and 134 are associated with each display device and client device combination respectively. For example, user 114 may provide input to client device 110 to retrieve collaboration data stored in the collaboration data system 170 and display a collaboration interface based on the collaboration data through display device 112.

The client devices 110, 120 and 130 may be a general purpose computing device such as a desktop or laptop computer, or any other sort of computing device. For example the client devices 110, 120 and 130 may be a thin client or netbook client device, a mobile device such as a smart phone, or any other data processing system of a user device. The client devices 110, 120 and 130 respectively include memory for storage of data and software applications, a processor for accessing data and executing applications, and input and output devices that allow user interaction. The client devices 110, 120 and 130 further include components that facilitate communication over communications network 140.

The network 140 may be a local proprietary (e.g. an intranet), local wide-area network (WAN), a private network, public network, the Internet, or a combination of these. The network 140 may be a local area network (LAN), which may be communicatively coupled to a wide area network (WAN) such as the Internet. The Internet is a broad network of interconnected computers and servers allowing for the transmission and exchange of Internet Protocol (IP) between users connected through a network service provider. Examples of network service providers are the public switched telephone network, a cable service provider, a provider of a digital subscriber line (DSL) services, or a satellite service provider. The network 140 allows for communication between the various components of the system 100.

Web server 150-1 and web server 150-2 are coupled to the network 140 to handle requests for content such as web pages from a browser application executing on a client device. Representative browsers include Microsoft Internet Explorer and Mozilla Firefox. A web server is a computing device and includes memory, a processor for accessing data and executing applications, and components to facilitate communication over the network 140 including communications with the client devices 110, 120 and 130.

The browser application on a client device is used to locate and display web pages (e.g. both textual and graphical data) stored on one or more web servers using HTML/Java based interfaces. In a typical situation, the user of a client device sends a request for a web page stored on a particular web server by entering the uniform resource locator (URL) of a web page stored on the web server into the browser application. When the web server receives the request it transmits the requested web page to the client device for display through the browser application. A web server may contain any number of web pages associated with any number of web sites. For example, a single web server may store and distribute (in response to user's request to view a page) web pages for several different companies or organizations. Although two web servers 150-1 and 150-2 are illustrated in FIG. 1, it will be understood that the system of FIG. 1 may include any number of web servers.

As described below, the browser application enables a user viewing a web page to also view a collaboration interface which provides access to view and add to a group of one or more collaboration data sets associated with the URL according to user defined organization. In embodiments the collaboration interface may for example be invoked automatically using code embedded within the page which is executed by the browser application during the display of the page. The embedded code causes the browser application to submit the URL or other unique identifying information of the page the user is viewing to the collaboration data system 170, and displays the collaboration interface. Alternatively, the collaboration interface may be invoked for example in response to a user selecting (e.g. clicking on) a bookmarklet icon located in a toolbar or a drop-down menu of the browser. A bookmarklet is a small JavaScript program that can be stored in the browser in a bookmark. Selecting the bookmarklet causes the associated script to execute. As described in more detail below, the bookmarklet includes code for submitting the URL or other unique identifying information of the page to the collaboration data system 170. The collaboration data system 170 then determines collaboration data sets associated with the user and further associated with the URL of the page, and returns identification information which can be used to display icons representing the associated collaboration data sets.

The collaboration data system 170 is coupled to the network 140 for managing and handling requests for collaboration data sets to provide contextual collaboration functionality within the browser application.

A collaboration data set is a set of one or more items of content stored in collaboration database 172 which are associated with the collaboration data set according to participant defined organization. This organization is maintained by the collaboration server 174 and associated with participant accounts of participants having shared access to view and/or modify the collaboration data sets. The collaboration data set provides participants a platform for continued collaboration functionality which is de-centralized from the web pages the users are viewing. The collaboration data set enables asynchronous collaboration functionality including continued collaboration, resuming collaboration, and the sharing of collaboration on the same subject.

An item of content may include participant comments, audio and/or visual data such as, for example, an image, a webpage, text, a video, a document, an electronic mail message, SMS message content, MMS message content, and any portions and/or combinations thereof. Metadata may also be associated with the item of content. The metadata may specify the uniform resource locator (URL), file pointer, tags, or other information which provides an identity of the source such that the participant can return to the original source of the item of content. The original source may also be stored in the collaboration database 172. The metadata may include text within the visual data, participant added comments, and any other non-visual data. This metadata text may be extracted from captured visual data using optical character recognition (OCR) techniques, or as another example may be extracted by interrogation of the operating system during the capturing process.

An item of content may be participant generated based on visual data captured from a data source and sent to the collaboration data system 170 through a capture process executable by a collaboration application (such as collaboration application 118, 128 or 138 of FIG. 1). The data source may be for example a web page, an image, an electronic mail message, a document such as a word processing document, spreadsheet, presentation slide deck, or any other source of data that can be visibly displayed on a display device through a source application on the client device. Examples of source applications include a web browser, a word processing application, and any other application which can be visibly displayed on a display device.

The collaboration application may be implemented for example as a desktop application, client application, or stand-alone application. In some embodiments, the collaboration application may execute in the background. The collaboration application may install several buttons on a toolbar of a source application (such as a browser or word processing application), or as a stand-alone toolbar on a user's desktop. When a user clicks one of these buttons, the collaboration application starts the process of capturing the visual data of a data source displayed through the source application, preferably without the user having to navigate away from that data source. Alternatively, start of the collaboration application may be accessible by other means such as a keyboard shortcut. An alert window may also be located on the toolbar, which serves to notify the user of a new item of content in an associated collaboration data set without requiring the user to be viewing the particular page. The collaboration application also allows users to receive, view and respond to alerts to add content inside the associated collaboration data set on top of the web page the user is currently viewing. A user may also be alerted when a shared collaboration data set is linked to a new page by another user.

Various techniques can be used to carry out the selection of the visual data of the data source to be captured. Such a selection may be made, for example, by a user input to the corresponding client device moving the cursor and clicking the left mouse button to identify the upper-left corner of the selected region and then releasing the left mouse button when the cursor is in the lower-right corner of the selected region. As another example, a region of selection may be defined via user input to a touch sensitive display. In this example, a touch to an upper-left portion and a lower-right portion may be interpreted as a region of selection. A region of selection may be defined for example by a square, rectangle, circle, ellipse, etc. One of several possible shapes may be specified and the region of selection may be specified according to a method depending on the selected shape. For example, if a circle is selected, the user may define the region by identifying the point at the center of the circle and a point on the perimeter of the circle. In some embodiments, the shape of the region can be modified after it is initially defined by selecting and moving points defining the shape.

One or more icons representing corresponding collaboration data sets may be provided within or overlying the user interface of the source application by the collaboration application. The selected region can then be dragged and dropped into an icon representing the appropriate collaboration data set. The selected region and the associated metadata form an item of content which is associated with the appropriate collaboration data set. The item of content is then sent to the collaboration data system 170 for storage in the collaboration database 172 and made available to other participants according to the sharing permissions granted. Items of content may also be subsequently modified, and may also be “cut” or “copied” from one collaboration data set and “pasted” to another in response to user input.

Items of content such as participant comments may also be associated with the corresponding collaboration data set using the collaboration application by navigating trough a menu displayed on the client device to select the appropriate corresponding collaboration data set. This enables the user to see a comment or a piece of content, add a comment, and reply to a comment without opening the associated page or document, nor opening the particular collaboration data set.

The collaboration application allows items of content to be placed into a collaboration data set associated with one or more pages without requiring separate use of a standalone application, making it easier to add collaboration content to the collaboration data sets.

The collaboration application may also enable the user to store the original source of the item of content such as an image, an electronic mail message, a document such as a word processing document, spreadsheet, presentation slide deck, etc., in the collaboration database 172 to allow easy access to the original source document to participants.

The operation of the collaboration application and the collaboration data system may be further understood by review of co-pending U.S. application Ser. No. 12/324,697, entitled “Systems and Methods for Capturing, Organizing, and Sharing Data”, filed 26 Nov. 2008, which is incorporated herein by reference.

The collaboration server 174 is a computing device and includes memory, a processor for accessing data and executing applications, and components to facilitate communication over the network 140. The collaboration server 174 includes a collaboration manager module 178 which handles requests for collaboration data sets and supports manipulation and creation of the collaboration spaces, including saving, copying and deletion items of content in the collaboration database 172. As described below, the collaboration server 174 supports requests for stand-alone access of the collaboration spaces via a direct log-in process through the entry of participant names and passwords which are verified by the collaboration server 174. As a result, the collaboration data sets are accessible to a user who may not have direct access to the associated page.

The collaboration server 174 handles requests for identification information of one or more collaboration data accessible to the user which are associated with a URL of the page displayed through the application according to user defined organization. The collaboration server 174 also supports requests to modify and update association data between URL's and collaboration data sets for the user.

In addition, the collaboration server 174 supports requests for access to view and add to the collaboration data sets through a collaboration interface within the browser's user interface, even if the user does not have a collaboration application installed on their user device. Users that add or view the data associated with the data set or participate in providing content associated with the added content, such as by providing comments, participate in collaboration associated with the particular collaboration data set (i.e., data that has been associated with the data set). As described below, the collaboration interface includes icons selectable to provide access to a group of one or more collaboration data sets associated with a URL of the page displayed through the browser according to user defined organization. A user can also access collaboration data sets through the collaboration interface which are not linked to the page currently displayed through the browser.

The collaboration server 174 supports creation and manipulation of collaboration data sets through the collaboration interface within the browser application and other applications. This includes the saving, copying and deletion of items of content. The collaboration server 174 may be a web server which delivers content using HTTP/HTTPS.

The collaboration manager module 178 also supports search and query functions of the collaboration data sets and the items of content. These search and query functions can be specific to the collaboration data sets associated with a particular web page the user is viewing, or may be for all of the collaboration data sets associated with the user. The collaboration manager module 178 also handles permission control capability with regard to the collaboration data sets via participant verification information which may be stored in the collaboration database 172. The participant verification information allows the collaboration server 174 to authenticate participants using for example a direct log-in process. In such a process, the collaboration server 174 provides an interface for participant entry of a name and password, and uses the verification information to determine whether a participant has permission to access a particular collaboration data set.

The owner or creator of a collaboration data set can specify participants that can access that content and access privileges, for example by specifying a delegate and/or by specifying classifications of groups of participants. Furthermore, in some cases the owner can specify one or more administrators that also have permission control capabilities. The accessibility of a collaboration space may be controlled for particular participants and/or groups of participants. For example, some participants may have permission to read and add items of content, while other participants have read-only permission. A user can update the permissions of one or more collaboration data sets within the user interface of the browser application.

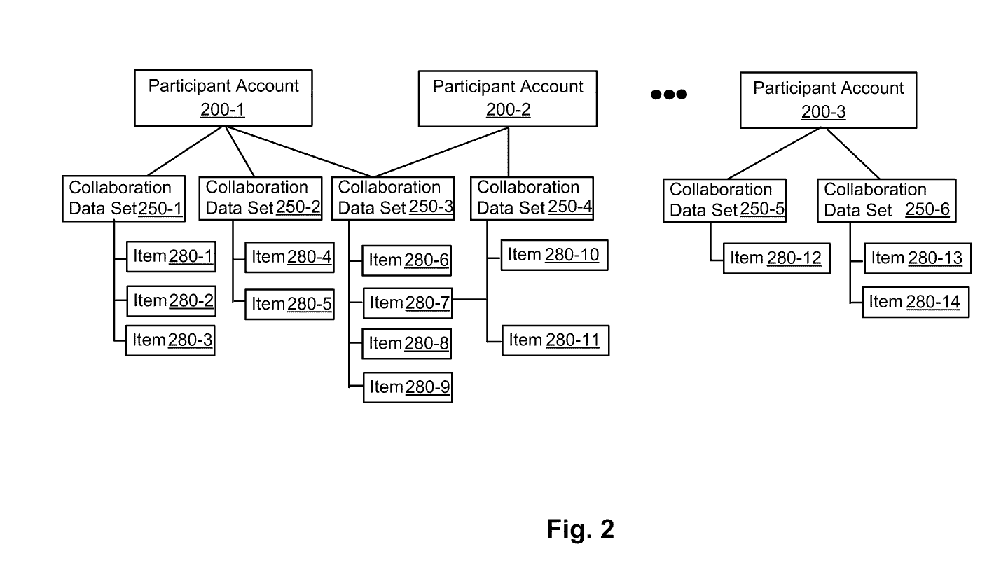

FIG. 2 illustrates an example hierarchical data model diagram for the collaboration data sets within the collaboration data system 170. The example data model diagram shows the relationship between items of content 280-1 to 280-14 (respectively labeled “item” in FIG. 2), collaboration data sets 250-1 to 250-6, and participants accounts 200-1 to 200-3 of participants having shared access to the corresponding collaboration data sets 250-1 to 250-6. For example, collaboration data set 250-3 includes items of content 280-6 to 280-9, and participant account 200-1 and participant account 200-2 have shared access to the collaboration data set 250-3.

In FIG. 2, each of the collaboration data sets 250-1 to 250-6 includes one or more items of content. A collaboration data set may also include no items of content, such as may occur immediately following its creation.

The same item of content may be associated with one or more collaboration data sets. For example, item 280-7 is associated with collaboration data set 250-3 and 250-4.

A collaboration data set may be a private collaboration data set which is associated with a single participant account (e.g. collaboration data set 250-6) , may be a shared collaboration data set which associated with two or more participant accounts (e.g. collaboration data set 250-3), or may be a public collaboration data set which is accessible by any participant account.

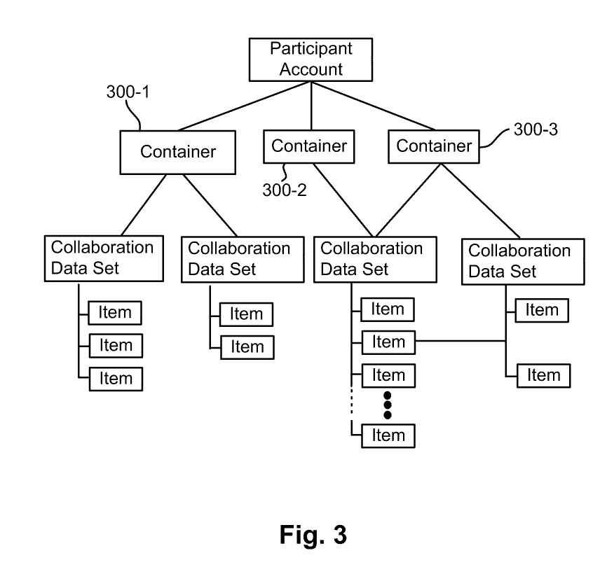

In some embodiments, the data model diagram for the collaboration data sets within the collaboration data system 170 includes one or more containers. A container may contain one or more collaboration data sets arranged according to user defined organization. One such example data model diagram which includes containers is illustrated in FIG. 3. As shown in FIG. 3, container 300-1 includes collaboration data set 350-1 and collaboration data set 350-2. A collaboration data set may also be shared among containers, as is shown for collaboration data set 350-3 and containers 300-2 and 300-3.

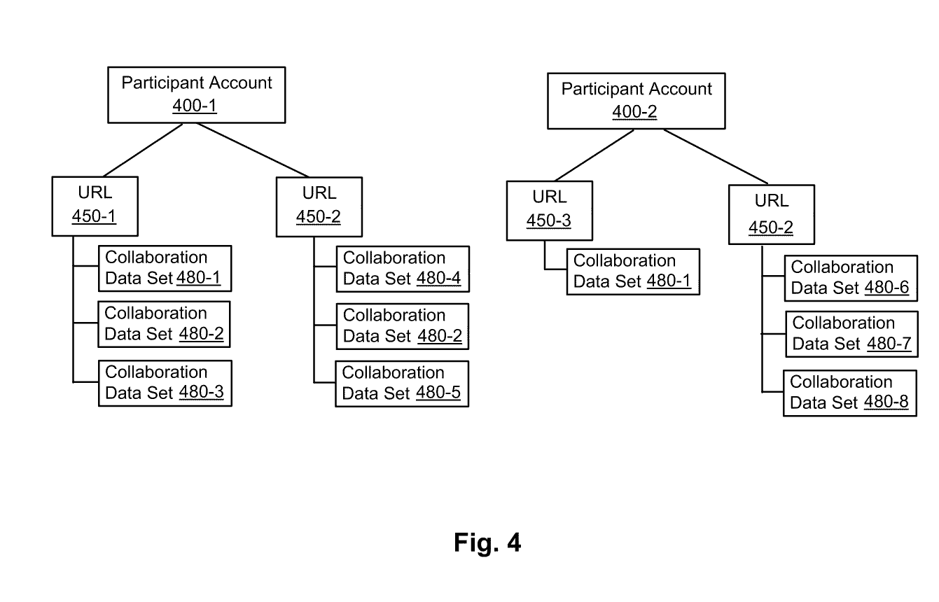

FIG. 4 is an illustration of an example association between URL's and a user's accessible collaboration data sets. In FIG. 4, participant account 400-1 has access to collaboration data sets 480-1 to 480-5, and participant account 400-2 has access to collaboration data sets 480-1 and 480-6 to 480-8.

As depicted in FIG. 4, collaboration data sets 480-1 to 480-3 associated with the participant account 400-1 are further associated with the URL 450-1. Similarly, collaboration data sets 480-2, 480-3 and 480-4 associated with the participant account 400-1 are associated with the URL 450-2. Thus, when the user of the participant account 400-1 accesses the web page corresponding to the URL 450-1, the collaboration interface within the browser's interface includes icons selectable to provide access to the collaboration data sets 480-1 to 480-3. As a result, the user of the participant account 400-1 can maintain multiple contextual collaborations around the same web page with different groups of users. For example, the collaboration data set 480-1 and 480-2 may be accessible to different groups of users. Similarly, when the user of the participant account 400-2 accesses the web page corresponding to the URL 450-2, the collaboration interface includes icons selectable to provide access to the collaboration data sets 480-2, 480-4 and 480-5. Thus, in this case collaboration data set 480-2 establishes a direct collaboration link between the different URL's 450-1 and 450-2.

The association between URL's and the collaboration data sets is contextual to the user. As a result, separate users accessing the same web page have customizable collaboration interfaces which can provide access to completely different groups of collaboration data sets. This web page may be for example a dashboard or report, or any other type of web page. Thus, when accessing a web page, each user sees a custom collaboration interface which is contextual to the user and the web page. For example, the user of participant account 400-2 will see icons selectable to provide access to collaboration data sets 480-6 to 480-8 when viewing the web page corresponding to the URL 450-2. This is in contrast to the user of participant account 400-2, which will see icons for collaboration data sets 480-2, 480-4 and 480-5 when viewing the same web page. Depending upon the user-defined organization, separate users accessing the same web page may also have collaboration interfaces which each include access to the same collaboration data set shared among the users.

The association between URL's and the collaboration data sets may also be contextual to a group of users, such that members of a particular user group or user role may have a default set of associated collaboration data sets for a particular web page. This default set may be directly associated with a particular web page for all users of a group. Alternatively, the default set may be suggested to a user, such that a user accepts the suggestion before one or more of the default collaboration data sets become associated with the particular web page. These box assignments or suggestions may be made by a group administrator, or by a group member.

The association between URL's and the collaboration data sets may be specific to one URL, so that a user will only see the icons for those associated collaboration data sets when viewing a particular web page. The association can also be specific to a group of URL's, so that the user will see icons for those associated collaboration data sets when viewing any web page in the group. For example, the association may be relative to a base URL, so that the user will see the same icons for when viewing any web page having a URL which includes that base URL. The base URL can be for example the host name of the URL of the web page.

The association between the page and collaboration data sets can be at different levels within the page, such as at the page or screen level, a record or object, or a field. The association can also be specific to other information about the users environment, such as the user's IP address (e.g. whether the user is inside or outside a corporate firewall), a user's browser or device (e.g. whether the user is on a PC-based web browser or a mobile device such as a smart-phone or iPad), a user's geographical location, and a user's operating system. The user may then be presented with a different set of collaboration data sets when viewing a particular web page based on any or all of these factors.

The association with a page can also extend beyond the collaboration data sets. For example, contacts or groups of contacts could also be associated with the particular page in the same fashion as described above. This enables communication actions to be triggered with those contacts or groups of contacts directly from within the context of the page.

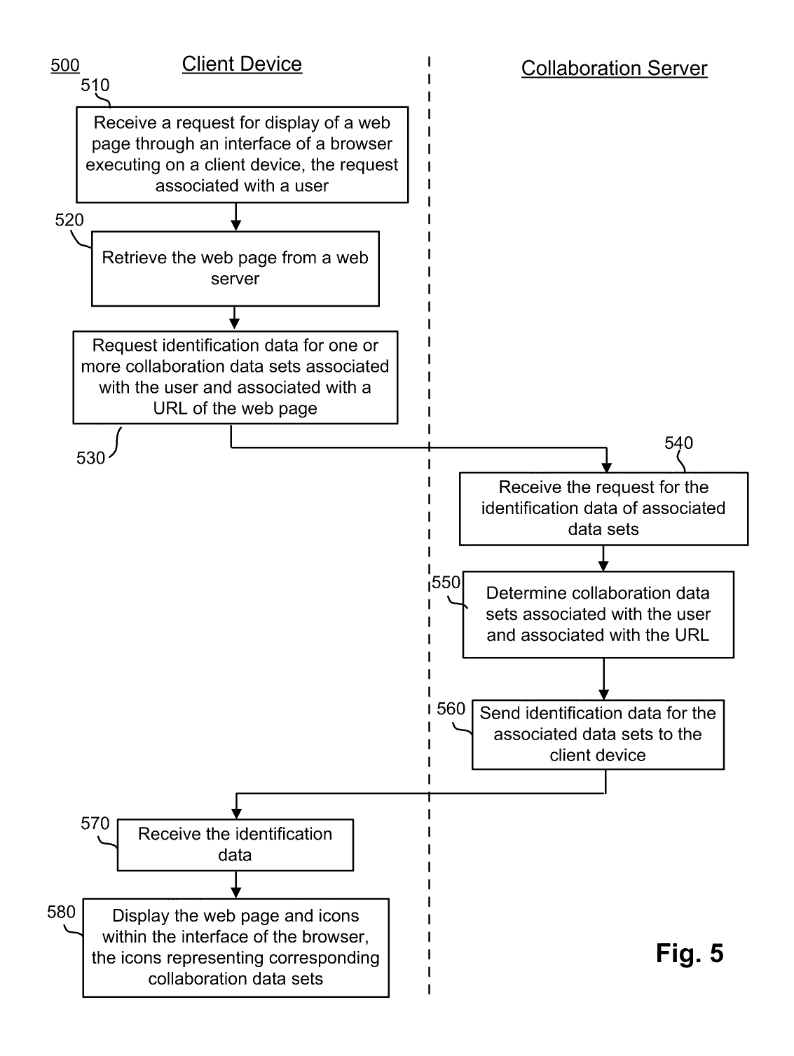

FIG. 5 is a flow chart of an exemplary computer implemented method 500 for providing a collaboration interface including selectable icons to collaboration data sets contextual to the user and the URL of the web page accessed by the user.

At step 510 the client device associated receives a request for display of a web page through an interface of a browser application executing on a client device. A user (e.g. user 114 of FIG. 1) may initiate the request by navigating a user interface displayed by the browser application (e.g. browser application 115) on the display device (e.g. display device 112) of the client device (e.g. client device 110) to enter the URL of a web page stored on a web server (e.g. web server 150-1).

At step 520 the client device sends the request for the web page to the web server. When the web server receives the request it transmits the requested web page to the client device for display through the browser application.

At step 530 the client device sends a request for identification data for one or more collaboration data sets associated with the user and associated with a URL of the web page to the collaboration server 174.

Step 530 may for example be invoked automatically using code embedded within the web page content which is executed by the browser application during the display of the web page. The embedded code causes the browser to submit the URL or other unique identifying information associated with the URL to the collaboration data system 170. The embedded code may be implemented as an iframe, script code such as Java script, or some other type of code. In some embodiments, the embedded code may specify a default set of one or more collaboration data sets, such that all users who view the particular web page will see icons selectable for the default set, as well as any specific collaboration data sets the user has associated with the web page.

Alternatively, step 530 may be invoked in response to a user selecting (e.g. clicking on) a bookmarklet icon located in a toolbar or a drop-down menu of the browser application. This selection may occur after the page has been displayed. A bookmarklet is a small JavaScript program that can be stored in the browser in a bookmark. Selecting the bookmarklet causes the associated script to execute. The bookmarklet includes code for submitting the URL of the page the user is viewing through the browser application to the collaboration data system 170. The bookmarklet enables the user to associate collaboration data sets with the page without any special preparation or setup of the page by anyone such as an administrator.

At step 540 the collaboration server 174 receives the request for the identification data of associated data sets. Upon receiving the request, the collaboration server 174 may indentify the user by obtaining user identification data directly from the user, for example by looking at cookies or other identifying information stored on the user's client device. In an alternative, the collaboration server 174 may rely on a log-in process for authentication and identification of the user. In yet another alternative, the rules to access the particular page can be synchronized with the collaboration data system 170 access rules.

If the user has not previously associated a collaboration data set with the URL, the user may be presented with an interface which guides the user through a selection process for associating the URL with one or more collaboration data sets. This selection process is described in more detail below.

At step 550 the collaboration server 174 searches the collaboration database 172 to determine collaboration data sets associated with the user and associated with the URL. The determination of the associated collaboration data sets can also be specific to the content of the page. For example, the content of a document, or page, or field, can be detected and used in the determination of the association of one or more collaboration data sets. This content might include textual elements, data values, metadata, or image data that is present in the page. This content data may be dynamically queried from the web page, and additional analysis of that data may be performed to help analyze the content. This may include for example text parsing and analysis, data mining, and image processing/image pattern recognition. At step 560 the collaboration server 174 sends identification data for the associated collaboration data sets to the client device. The identification data may include user defined names for the associated collaboration data sets.

At step 570, the client device receives the identification data. At step 580 the web page and a collaboration interface which includes icons are displayed within the interface of the browser. The icons represent corresponding collaboration data sets, and are selectable by the user to display collaboration data associated with the corresponding collaboration data set. In this manner, the icons allow collaboration data from collaboration activities conducted outside the web page to be contextually viewed seamlessly within the interface of the browser application. The icons may also include a visual indicator to alert the user to the presence and/or quantity of “unread” items of content in the corresponding collaboration data set. The icons may also include a different visual indicator that changes when the corresponding collaboration data set has different types of new items of content.

The icons may include a visible display of the identification data such as the user defined names for the associated data sets, so that such identification data is conveyed to the user. The icons may be automatically displayed within a predefined portion of the web page. Alternatively, a user interface element such as a tab within the interface of the browser application may be selectable to display and conceal the icons.

A user can also view a report of all web pages or other target locations that a given collaboration data set has been associated with by the user, and/or by other users with whom the collaboration data set is shared.

The visual nature of the collaboration interface facilitates the process of finding and managing content and conversations related to a target location.

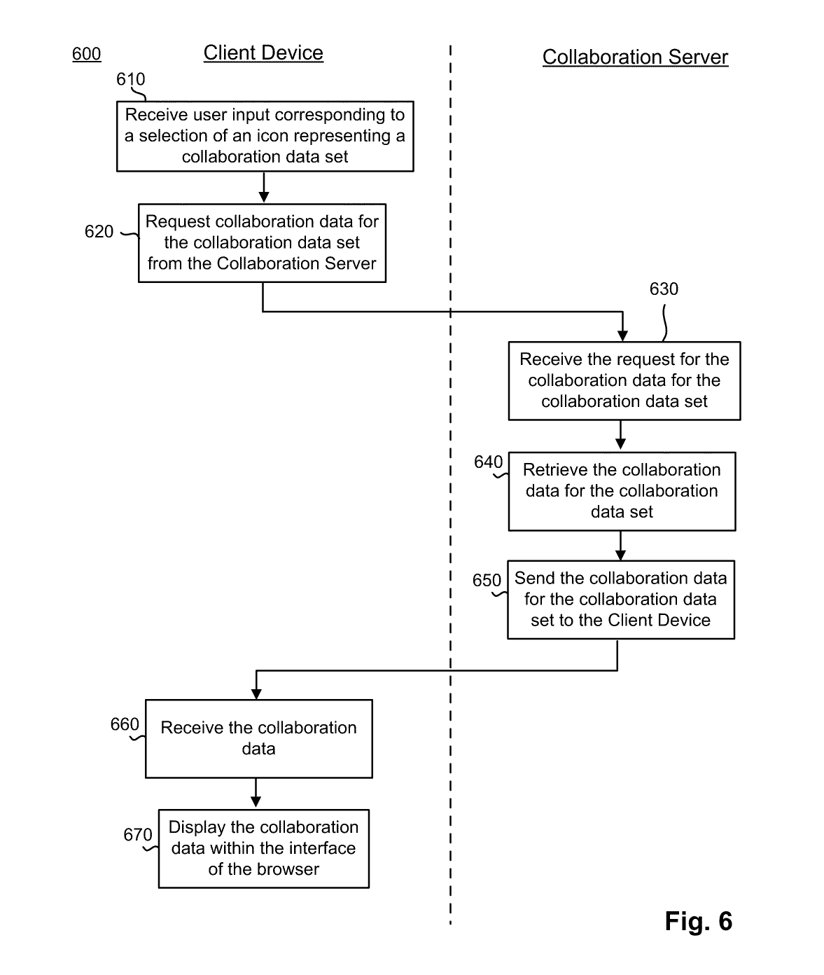

FIG. 6 is a flow chart of an exemplary computer implemented method 600 for displaying collaboration data associated with the corresponding collaboration data set in response to a selection of an icon by the user.

At step 610 the client device receives user input corresponding to a selection of an icon representing a collaboration data set. At step 620 the client device requests the collaboration data of the collaboration data set represented by the selected icon from the collaboration server 174. At step 630 the request for the collaboration data is received by the collaboration server 174.

At step 640 the collaboration server 174 retrieves the collaboration data for the collaboration data set from the collaboration database 172. As described above, the collaboration server 174 may verify that the user is authorized to access the collaboration data set based on stored permission information. At step 650 the collaboration server 174 sends the collaboration data for the collaboration data set to the client device.

At step 660 the client device receives the collaboration data. At step 670 the client device displays the collaboration data within the user interface of the browser application. This collaboration data may be embedded within a portion of the web page, of may be displayed for example within a new window. In this manner, the collaboration data of the collaboration data set is embedded or otherwise made visibly available from within the browser application's user interface.

In embodiments in which the collaboration data is displayed within a new window overlying the page, this new window can be both movable and resizable. This enables the user to interact with both the page and the collaboration data of the data set (content and collaboration) simultaneously, and in the same context together.

The user may also select more than one icon at a time, enabling the user to activate/deactivate one or many of the collaboration data sets simultaneously, all in the context of the web page the user is viewing. This enables the user to view the content of multiple collaboration data sets on top of the web page the user is viewing.

In some embodiments, the user may also drag-and-drop content from the collaboration data set into the page.

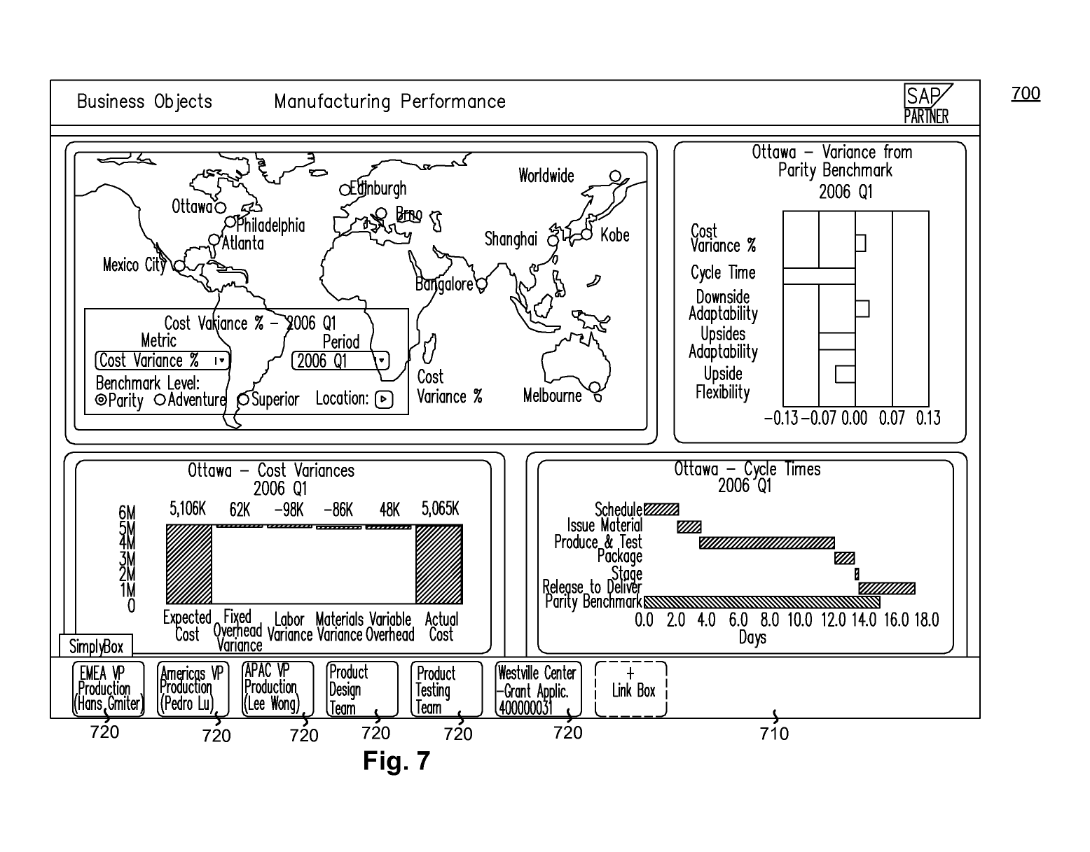

FIG. 7 illustrates a user interface 700 showing an example web page which includes a collaboration interface 710. The collaboration interface 710 includes icons 720 selectable to provide access to corresponding collaboration data sets associated with the URL of the web page and the user viewing the web page. As a result, the collaboration data is seamlessly accessible by the user within the context of the web page they are viewing.

In embodiments the collaboration interface 710 may alsoincludes a hierarchical configuration of the icons such as tabs representing containers. As described above, a container may contain one or more collaboration data sets arranged according to user defined organization. The user can select a tab to view the icons representing the collaboration data sets within the corresponding container, while the icons for the other containers are concealed when its tab is not selected. In this manner, the user can have access to a large number of collaboration data sets without cluttering the collaboration interface 710.

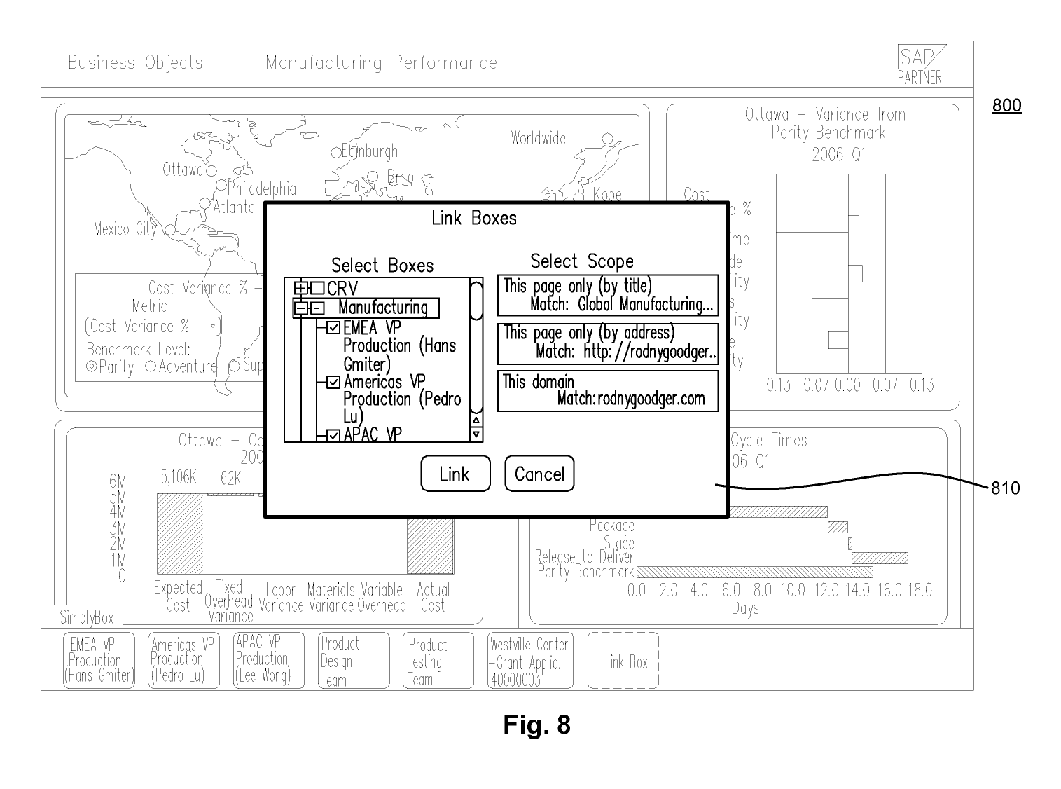

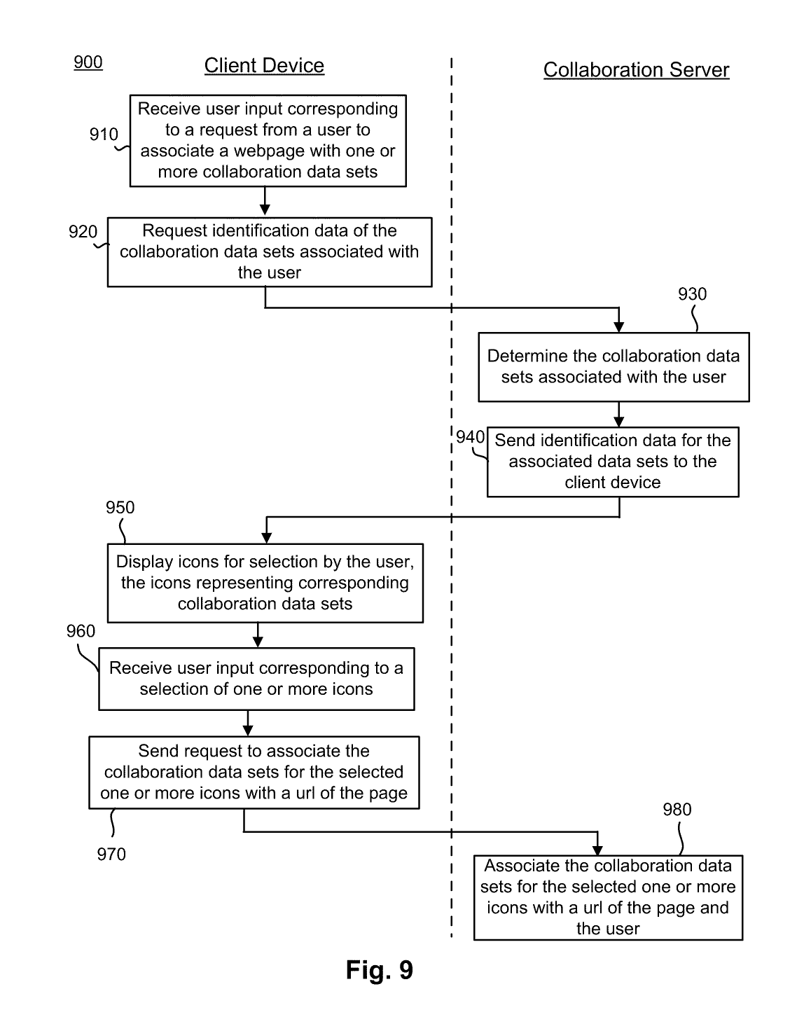

FIG. 8 illustrates a user interface 800 showing the example web page of FIG. 7 which includes display of a menu 810 used associate the URL of the web page with one or more collaboration data sets. The menu can be displayed in response to user input such as clicking on the “Link Box” button provided in the collaboration interface 710 shown in FIG. 7. The menu 810 includes a list of names of collaboration data sets associated with user, which are selectable by the user to indicate the collaboration data sets to be associated with the URL of the web page. The method for associating one or more collaboration data sets with a URL of the web page is described in more detail below with respect to FIG. 9.

FIG. 9 is a flow chart of an exemplary computer implemented method 900 for associating a URL with one or more collaboration data sets according to user defined organization.

At step 910 the client device receives a request to associate the URL of a web page with one or more collaboration data sets. A user can initiate the request for example by clicking on a “Link” button provided on the browser's user interface when viewing the web page. Alternatively, the request can be initiated for example if the user attempts to view the collaboration interface with no preexisting association between the URL and the user's collaboration data sets. As described above, this identification data may include user defined names for the associated collaboration data sets.

At step 920 the client device requests identification data of the collaboration data sets associated with the user to the collaboration server 174. At step 930 the collaboration server 174 determines the collaboration data sets associated with the user. At step 940 the collaboration server 174 sends identification data for the associated data sets to the client device.

At step 950 the user is presented with an interface which displays icons for selection by the user, the icons representing corresponding collaboration data sets. The icons represent corresponding associated collaboration data sets, and are selectable by the user for associating the collaboration data sets with the URL of the web page. The icons may include a visible display of the identification data such as the user defined names for the associated data sets. Alternatively, the interface may display a menu for selection such as a list of the names of the associated collaboration data sets for selection by the user.

At step 960 the client device receives user input corresponding to a selection one or more icons representing collaboration data sets to be associated with the URL of the web page. The association may be specific to the particular URL of the page. Alternatively, the user may select to associate for example a base URL of the URL of the web page with the selected collaboration data set(s). The user may also create a new collaboration data set to be associated with the URL by clicking on a “New” button, which sends the request to create the new collaboration data set to the collaboration server 174.

At step 970 the client device sends the request to the collaboration server to associate the collaboration data sets for the selected one or more icons with the URL of the page. At step 980 the collaboration server 174 updates the association data of the collaboration data sets represented by the selected one or more icons with the URL of the page and the user. The association between the page and collaboration data sets can be at different levels within the page, such as at the page or screen level, a record or object, or a field.

As will be understood, the specific functions of servers and client devices described herein may be implemented in software executed by a general purpose computer and/or specialized hardware designed to implement the specific functions.

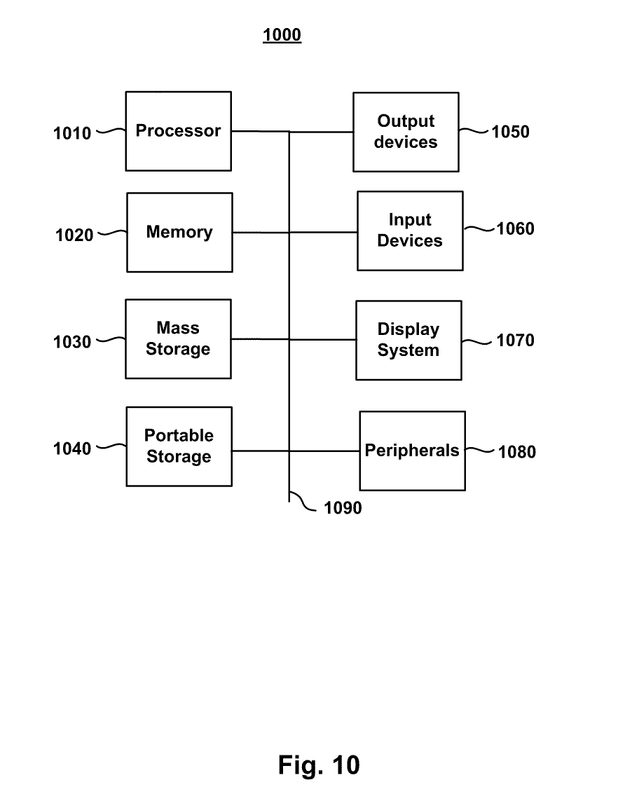

FIG. 10 illustrates an exemplary computing system 1000 that may be used to implement aspects of the present invention. System 1000 of FIG. 10 may be implemented in the contexts of the likes of collaboration server 174, web server 150-1, web server 150-2, collaboration database 172, and client devices 110, 120, 130. The computing system 1000 includes one or more processors 1010 and memory 1020. Main memory 1020 stores, in part, instructions and data for execution by processor 1010. Main memory 1010 can store the executable code when in operation. The system 1000 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1010 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same is the same as the predecessor signal, event or value, this is merely a degenerate case in which the given signal, event or value is still considered “responsive” to the predecessor signal, event or value. “Dependency” of a given signal, event or value upon another signal, event or value is defined similarly.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method comprising:
receiving a request for display of a first page through an interface of an application executing on a computing device, the request associated with a user;
retrieving identification data of one or more collaboration data sets associated with the user and further associated with a uniform resource locator (URL) of the first page;
displaying the first page within the interface of the application; and
displaying one or more icons within the interface of the application, the one or more icons representing a corresponding collaboration data set in the one or more collaboration data sets, the icons selectable to display collaboration data associated with the corresponding collaboration data set.

2. The method of claim 1, further comprising:
receiving a user input corresponding to a selection of a first icon in the one or more icons, the first icon representing a first collaboration data set in the one or more collaboration data sets; and
displaying the collaboration data associated with the first collaboration data set in response to receiving the user input.

3. The method of claim 1, wherein the displaying one or more icons comprises displaying a hierarchical configuration of the one or more icons.

4. The method of claim 1, further comprising displaying a user interface element within the interface of the application, the user interface element selectable to display and conceal the one or more icons.

5. The method of claim 1, wherein the step of displaying one or more icons is in response to receiving the receiving the request for display of the first page.

6. The method of claim 1, wherein the one or more collaboration data sets is a subset of collaboration data sets associated with the user.

7. The method of claim 1, wherein the one or more collaboration data sets is associated with a base of the URL.

8. The method of claim 1, wherein the collaboration data and the one or more collaboration data sets is stored in a collaboration database accessible viable a network.

9. The method of claim 1, wherein the one or more collaboration data sets are selected by the user.

10. The method of claim 1, further comprising requesting an association of a second one or more collaboration data sets with a second uniform resource identifier for a second page in response to a user input.

11. The method of claim 1, further comprising:
receiving a second request for display of the first page through an interface of a second application executing on a second computing device, the second request associated with a second user; and
retrieving second identification information of a second one or more collaboration data sets associated with the second user and further associated with the URL of the first page, wherein at least one collaboration data set in the second one or more collaboration data sets is not within the one or more collaboration data sets associated with the user.

12. The method of claim 11, wherein at least one collaboration data set is common between the one or more collaboration data sets associated with the user and the second one or more collaboration data sets associated with the second user.

13. A computer readable storage medium having embodied thereon a program, the program being executable by a processor to perform a method, the method comprising:
receiving a request for display of a first page through an interface of an application executing on a computing device, the request associated with a user;
retrieving identification data of one or more collaboration data sets associated with the user and further associated with a uniform resource locator (URL) of the first page;
displaying the first page within the interface of the application; and
displaying one or more icons within the interface of the application, respective icons in the one or more icons representing a corresponding collaboration data set in the one or more collaboration data sets, the icons selectable to display collaboration data associated with the corresponding collaboration data set.

14. The computer readable storage medium of claim 13, further comprising:
receiving a user input corresponding to a selection of a first icon in the one or more icons, the first icon representing a first collaboration data set in the one or more collaboration data sets; and
displaying the collaboration data associated with the first collaboration data set in response to receiving the user input.

15. The computer readable storage medium of claim 13, wherein the displaying one or more icons comprises displaying a hierarchical configuration of the one or more icons.

16. The computer readable storage medium of claim 13, further comprising displaying a user interface element within the interface of the application, the user interface element selectable to display and conceal the one or more icons.

17. The computer readable storage medium of claim 13, wherein the step of displaying one or more icons is in response to receiving the request for display of the first page.

18. The computer readable storage medium of claim 13, wherein the one or more collaboration data sets is a subset of collaboration data sets associated with the user.

19. The computer readable storage medium of claim 13, wherein the one or more collaboration data sets is associated with a base of the URL.

20. The computer readable storage medium of claim 13, wherein the collaboration data and the one or more collaboration data sets is stored in a collaboration database accessible viable a network.

21. The computer readable storage medium of claim 13, wherein the one or more collaboration data sets are selected by the user.

22. The computer readable storage medium of claim 13, further comprising requesting an association of a second one or more collaboration data sets with a second uniform resource identifier for a second page in response to a user input.

23. The computer readable storage medium of claim 13, further comprising:
receiving a second request for display of the first page through an interface of a second application executing on a second computing device, the second request associated with a second user; and
retrieving second identification information of a second one or more collaboration data sets associated with the second user and further associated with the URL of the first page, wherein at least one collaboration data set in the second one or more collaboration data sets is not in the one or more collaboration data sets associated with the user.

24. The computer readable storage medium of claim 23, wherein at least one collaboration data set is common between the one or more collaboration data sets associated with the user and the second one or more collaboration data sets associated with the second user.
